(19) United States
(12) Patent Application Publication
(10) Pub. No.: US 2025/0114735 A1
(43) Pub. Date: Apr. 10, 2025

(54) ADSORPTION DEVICE

(71) Applicant: HONDA MOTOR CO., LTD., Tokyo (JP)

(72) Inventor: Hidetaka Ozawa, Wako-shi (JP)

(21) Appl. No.: 18/892,920

(22) Filed: Sep. 23, 2024

(30) Foreign Application Priority Data
Oct. 6, 2023 (JP) 2023-174435

(51) Int. Cl. B01D 53/04

(52) U.S. Cl. CPC B01D 53/0446; B01D 53/0438; B01D 2257/504

(57) ABSTRACT

An adsorption device includes disk-shaped adsorption module, and module holder for air insulation. The module holder includes a pair of end walls, a pair of connecting walls, a semi-cylindrical first shielding wall, and a semi-cylindrical second shielding wall. The pair of end walls are disposed on the adsorption modules of both end portions in a stacking direction with air distribution gaps sandwiched therebetween. The pair of connecting walls separate an outer circumferential portion of the plurality of air distribution gaps into an inflow region and an outflow region and connect outer circumferential edge portions of the pair of end walls. The first shielding wall shields 10 an outflow region outside the air distribution gap. The second shielding wall shields the inflow region outside the air distribution gap. The first shielding wall and the second shielding wall are disposed to alternately close the plurality of air distribution gaps in the stacking direction.

### CROSS-REFERENCE TO RELATED APPLICATION

Priority is claimed on Japanese Patent Application No. 2023-174435, filed Oct. 6, 2023, the content of which is incorporated herein by reference.

### BACKGROUND OF THE INVENTION

### Field of the Invention

The present invention relates to an adsorption device configured to adsorb target substances in air to be purified.

### Description of Related Art

Attempts have been made to mitigate or reduce the impact of climate change, and research and development is being conducted to reduce emissions of carbon dioxide (CO₂) or hazardous substances in order to achieve this goal.

As a device configured to remove target substances to be purified such as carbon dioxide (CO₂) in indoor air, there is known an adsorption device configured to purify by adsorbing target substances using an adsorbent (for example, see U.S. Pat. Nos. 11,007,470 and 9,751,039).

The adsorption device consists of a plurality of thin-type adsorption modules, each of which holds an adsorbent therein, and is stacked in a casing, and an air distribution channel is formed in a casing so that air is distributed to each of the adsorption modules in a plate thickness direction. The distribution channel is designed to allow air to flow in parallel in each of the adsorption modules in order to reduce pressure loss when air is distributed to the plurality of adsorption modules. Accordingly, when the adsorption device with this configuration is employed, the plurality of adsorption modules allows for efficient adsorption of the adsorption target substances in the air, and an output of a fan for flowing air through the adsorption module can be kept small.

### SUMMARY OF THE INVENTION

However, the adsorption device in the related art described above requires a complex passage shape inside the casing so that air can be distributed in parallel to each of the adsorption modules. For this reason, not only is manufacturing difficult, but also the air distribution resistance cannot be reduced sufficiently due to the complex passage shape.

An aspect of the present invention is directed to providing an adsorption device having a simple configuration capable of distributing air in parallel in a plurality of adsorption modules and that can reduce air distribution resistance, thereby facilitating manufacturing, improving the efficiency of adsorption and desorption of adsorption target substances, and saving energy in air distribution. This contributes to mitigating or reducing the impact of climate change.

An adsorption device according to an aspect of the present invention employs the following configurations.

That is, an adsorption device according to an aspect of the present invention includes a plurality of disk-shaped adsorption modules (for example, adsorption modules (20) of an embodiment) configured to hold an adsorbent (for example, an adsorbent (26) of the embodiment) therein and distribute air in a plate thickness direction; and a module holder for air insulation (for example, a module holder (15) of the embodiment) that has air distribution gaps (for example, air distribution gaps (16) of the embodiment) arranged in front of and behind each of the adsorption module in the plate thickness direction and that is configured to hold the plurality of adsorption modules in a stacked state, the module holder including: a pair of end walls (for example, end walls (17A, 17B) of the embodiment) disposed on the adsorption modules of both end portions in a stacking direction with the air distribution gap sandwiched therebetween; a pair of connecting walls (for example, connecting walls (18) of the embodiment) that are configured to separate an outer circumferential portion of the plurality of air distribution gaps into an outflow region facing a downstream-side air outflow chamber (for example, an air outflow chamber (12) of the embodiment) and an inflow region facing an upstream-side air inflow chamber (for example, an air inflow chamber (11) of the embodiment) and that are configured to connect outer circumferential edge portions of the pair of the end walls; a semi-cylindrical first shielding wall (for example, a first shielding wall (19F) of the embodiment) configured to shield the outflow region outside the air distribution gap; and a semi-cylindrical second shielding wall (for example, a second shielding wall (19S) of the embodiment) configured to shield the inflow region outside the air distribution gap, and wherein the first shielding wall and the second shielding wall being disposed to alternately close the plurality of air distribution gaps in the stacking direction.

In the adsorption device of the configuration, the outer circumferential portion of the plurality of air distribution gaps is separated into the inflow region and the outflow region by the pair of connecting walls of the module holders. Further, the plurality of air distribution gaps are alternately closed in the stacking direction by the first shielding wall configured to shield the outflow region from the air outflow chamber and the second shielding wall configured to shield the inflow region from the air inflow chamber. For this reason, the outflow region in the air distribution gap adjacent to each adsorption module is closed by the first shielding wall, and becomes an inflow gap through which air flows. In addition, the inflow region in the air distribution gap adjacent to each adsorption module is closed by the second shielding wall, and becomes an outflow gap through which air flows out. As a result, the plurality of adsorption modules, which are stacked, allow the air to flow from the inflow gap facing one surface of the adsorption module, and the air is distributed in the plate thickness direction. Then, the air distributed through the adsorption module in the plate thickness direction flows out toward the air outflow chamber through the outflow gap facing the other surface of the adsorption module.

The adsorption module may include a frame (for example, a frame (31) of the embodiment) configured to cover surroundings of the adsorption module in a direction crossing the plate thickness direction; an adsorbent (for example, an adsorbent (26) of the embodiment) disposed at inner side of the frame; and a heat exchange tube (for example, a heat exchange tube (47) of the embodiment) that is disposed at inner side of the frame together with the adsorbent and that is configured to allow heat exchange between a heat exchange fluid distributed in the heat exchange tube and surroundings of the adsorbent, the heat exchange tube may include an upstream tube region (for example, an upstream tube region (51) of the embodiment) disposed on one side of the heat exchange tube in the plate thickness direction; a downstream tube region (for example, a downstream tube region (52) of the embodiment) disposed on other side of the heat exchange tube in the plate thickness direction; and a substantially U-shaped turn-around region (for example, a turn-around region (47a) of the embodiment) configured to connect the upstream tube region and the downstream tube region, and wherein the heat exchange tube may be formed in a spiral shape such that the turn-around region is located on a substantially central portion at the inner side the frame.

In this case, when the heat exchange fluid is introduced into the heat exchange tube, the heat exchange fluid flows into the turn-around region located at substantially a center of the frame through the upstream tube region, and flows out to the outside from the turn-around region through the downstream tube region. Here, the heat exchange fluid flows in the upstream tube region and the downstream tube region in opposite directions (countercurrent). For this reason, for example, when the heat exchange fluid flowing through the heat exchange tube is a high temperature fluid for heating, in the upstream tube region, the heat exchange fluid flows toward the turn-around region on a central side of the frame while heating the adsorbent. The heat exchange fluid changes a direction in the turn-around region and flows toward the outside of the frame in the downstream tube region while further heating the adsorbent. Here, in the upstream tube region disposed on one side of the adsorption module in the plate thickness direction, a temperature of the heat exchange fluid inside gradually decreases from the outer side toward the inner side of the frame in the radial direction. Meanwhile, in the downstream tube region disposed on the other side of the adsorption module in the plate thickness direction, a temperature of the heat exchange fluid inside is gradually decreased from the inner side toward the outer side of the frame in the radial direction. Accordingly, an average temperature of the adsorption module in the plate thickness direction becomes substantially constant in the entire region in the radial direction, and desorption efficiency of the adsorption material from the adsorbent (regeneration efficiency of the adsorption module) is increased.

Further, when the heat exchange fluid flowing through the heat exchange tube is a cold fluid, similarly, since the heat exchange fluid flows in the upstream tube region and the downstream tube region in opposite directions (countercurrent), the average temperature of the adsorption module in the plate thickness direction can be reduced almost uniformly over the entire region in the radial direction. Accordingly, in this case, the adsorption efficiency of target substances during purification by the adsorbent can be increased.

The plurality of heat exchange tubes may be disposed at the inner side of the frame, and in at least one of the heat exchange tube, disposition of the upstream tube region and the downstream tube region in the plate thickness direction may be set to be opposite to the disposition of the other heat exchange tubes.

In this case, since the dispositions of the upstream tube region and the downstream tube region of all the heat exchange tubes in the plate thickness direction are not set to be same with each other, the deviation in temperature distribution in the plate thickness direction of the adsorption module can be reduced.

Arrangements of the upstream tube region and the downstream tube region of adjacent heat exchange tubes of the plurality of heat exchange tubes disposed at the inner side of the frame may be made opposite to each other in the plate thickness direction.

In this case, the dispositions of the upstream tube region and the downstream tube region of adjacent heat exchange tubes in the plate thickness direction are opposite, and the deviation in temperature distribution in the plate thickness direction of the adsorption module can be reduced.

At least one of the air inflow chamber and the air outflow chamber may constitute a pressure buffer configured to uniformize air pressure applied to the plurality of adsorption modules.

In this case, the pressure buffer makes it possible to equalize the air pressure applied to the plurality of adsorption modules, allowing the air to flow more uniformly to each adsorption module.

In the adsorption device according to the aspect of the present invention, the outer circumferential portion of the plurality of air distribution gaps is separated into the inflow region and the outflow region by the pair of connecting walls of the module holder, and the plurality of air distribution gaps are alternately closed in the stacking direction by the first shielding wall and the second shielding wall. For this reason, the adsorption device according to the aspect of the present invention has a simple structure that can reduce the distribution resistance of air, and can distribute the air in parallel to the plurality of adsorption modules. Accordingly, when the adsorption device according to the aspect of the present invention is employed, this allows for easier manufacturing, improved efficiency in adsorption and desorption of the adsorption target substances, and reduced energy consumption for air distribution.

Then, when the adsorption device according to the aspect of the present invention is employed, this can contribute to mitigating or reducing the impact of climate change.

### BRIEF DESCRIPTION OF THE DRAWINGS

FIG. 1 is a schematic cross-sectional view of an adsorption device of a first embodiment.

FIG. 2 is a perspective view of the adsorption device of the first embodiment, a casing of which is shown by a virtual line.

FIG. 3 is a perspective view of a main part of the adsorption device of the first embodiment, some members of which are removed.

FIG. 4 is a longitudinal cross-sectional view of the main part of the adsorption device of the first embodiment.

FIG. 5 is a perspective view of an adsorption module of the first embodiment.

FIG. 6 is an exploded perspective view of the adsorption module of the first embodiment.

FIG. 7 is an enlarged view of a portion VII in FIG. 5.

FIG. 8 is a schematic exploded cross-sectional view of the adsorption module of the first embodiment in a direction perpendicular to a thickness direction.

FIG. 9 is a cross-sectional view of the adsorption module of the first embodiment along line IX-IX of FIG. 5.

FIG. 10 is a schematic cross-sectional view of the adsorption module of the first embodiment in the direction perpendicular to the thickness direction.

FIG. 11 is a perspective view showing a state in which a heat exchange member of the adsorption module of the first embodiment is deployed.

FIG. 12 is a schematic cross-sectional view of an adsorption module of second embodiment in a direction perpendicular to a thickness direction.

FIG. 13 is a cross-sectional view along line XIII-XIII in FIG. 12.

### DETAILED DESCRIPTION OF THE INVENTION

Hereinafter, embodiments of the present invention will be described with reference to the accompanying drawings. Further, in each of the embodiments described in below, common pars are designated by the same reference signs. In description of a second embodiment, description of parts overlapping the description of the first embodiment will be partially omitted.

### First Embodiment

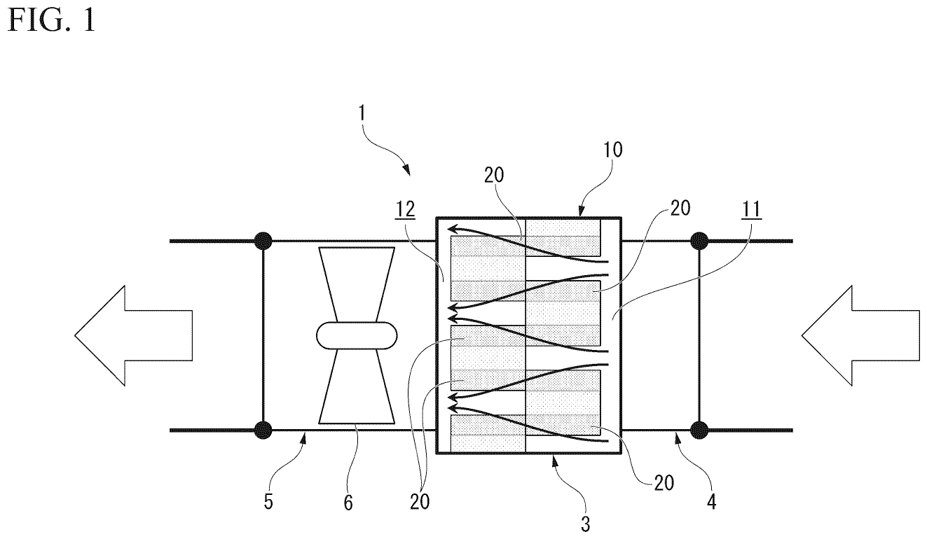

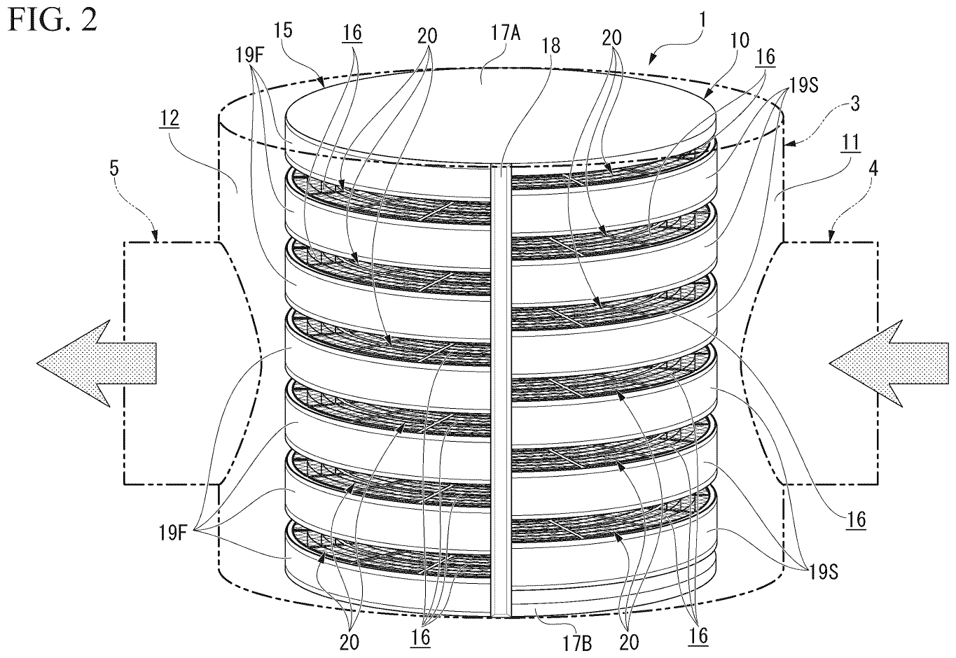

FIG. 1 is a schematic cross-sectional view of an adsorption device 1 of an embodiment. FIG. 2 is a perspective view of the adsorption device 1, a casing 3 of which is shown by a virtual line.

The adsorption device 1 of the embodiment is installed, for example, in a car compartment or inside a house, and adsorbs target substances, such as carbon dioxide (CO₂) or the like, contained in the air to be purified, using an adsorbent. While the target substances to be purified are not limited to carbon dioxide (CO₂), the following description assumes that the target substances to be purified are carbon dioxide (CO₂).

As shown in FIG. 1, the adsorption device 1 includes a device main body unit 10 having a function of adsorbing and removing target substances to be purified, the casing 3 configured to accommodate the device main body unit 10, and an inflow passage 4 and an outflow passage 5 connected to the casing 3. The device main body unit 10 includes a plurality of disk-shaped adsorption modules 20, and air is caused to flow in parallel through each of the adsorption modules 20, causing each of the adsorption modules 20 to adsorb carbon dioxide. In addition, desorption of the adsorbed carbon dioxide from the adsorption modules 20 is caused by heating the inside thereof and passing air for regeneration therethrough.

Further, in FIG. 1, the device main body unit 10 is schematically shown.

As shown in FIG. 2, the device main body unit 10 is formed in an approximately columnar shape as a whole. On the other hand, the interior of the casing 3 is formed in an elliptical cylinder shape when seen in a plan view. The device main body unit 10 is accommodated and disposed in the casing 3 to come into contact with an elliptical small diameter portion of an inner circumference of the casing 3. The device main body unit 10 comes into contact with an elliptical small diameter portion of the inner circumference of the casing 3 on outer surfaces of a pair of connecting walls 18 described below, and comes into contact with upper and lower walls of the casing 3 on outer surfaces of end walls 17A and 17B described below.

Accordingly, two space parts formed in an arc shape when seen in a plan view are formed between the elliptical large diameter portion of the inner circumference of the casing 3 and the device main body unit 10. One space part is an air inflow chamber 11 communicating with the inflow passage 4, and the other space part is an air outflow chamber 12 in communication with the outflow passage 5.

The inflow passage 4 is a passage configured to introduce indoor air to be purified or air for regeneration into the device main body unit 10 in the casing 3. The outflow passage 5 is a passage configured to discharge the air passing through the device main body unit 10 to indoor or outdoor. The outflow passage 5 is provided with an introduction fan 6 configured to introduce air into the device main body unit 10. Further, the air purified by the device main body unit 10 is returned indoors, and the air regenerated by the adsorption modules 20 in the device main body unit 10 is discharged outdoors.

Further, in the following description, with respect to the device main body unit 10, a side where the inflow passage 4 is located is referred to as “an upstream side,” and a side where the outflow passage 5 is located is referred to as “s downstream side.”

### Device Main Body Unit (Main Part of Adsorption Device)

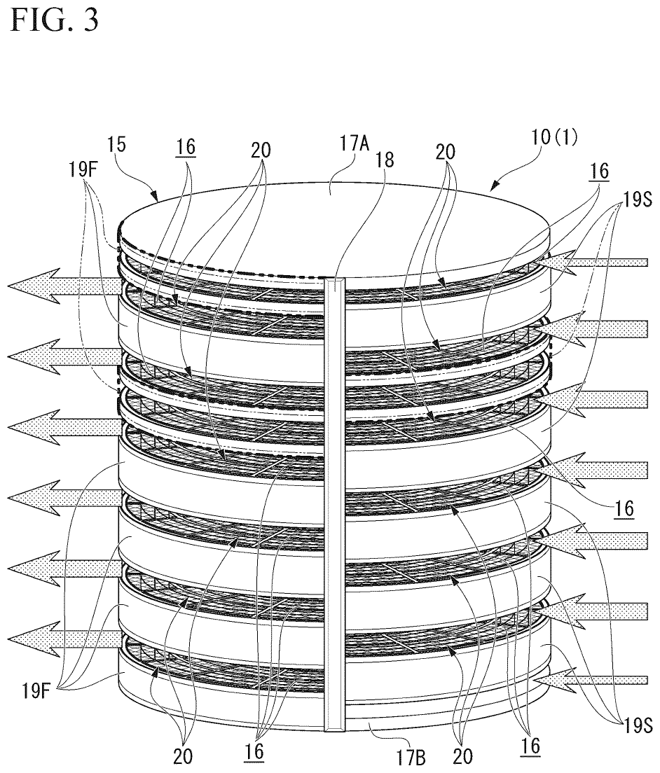

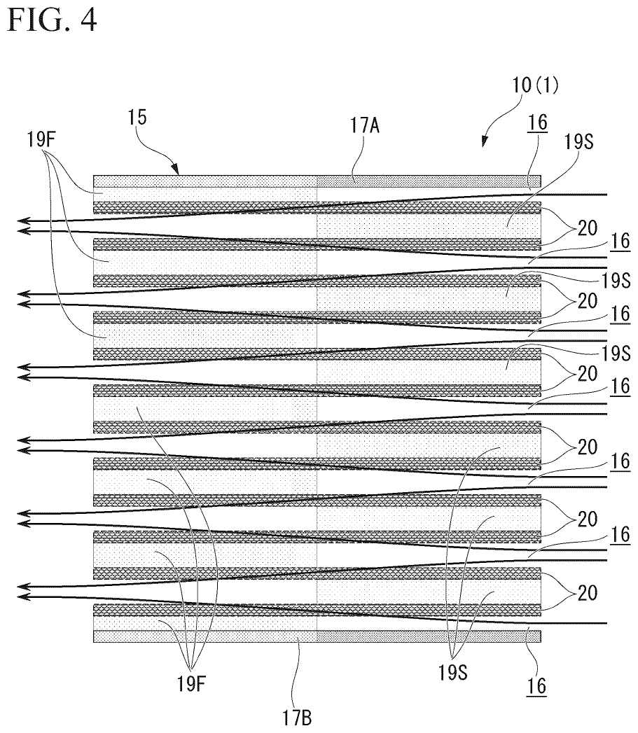

FIG. 3 is a perspective view of the device main body unit 10 (a main part of the adsorption device 1), a part of which is shown by a virtual line, and FIG. 4 is a longitudinal cross-sectional view of the device main body unit 10.

The device main body unit 10 includes the plurality of disk-shaped adsorption modules 20, and an air insulation module holder 15 configured to hold the plurality of adsorption modules 20.

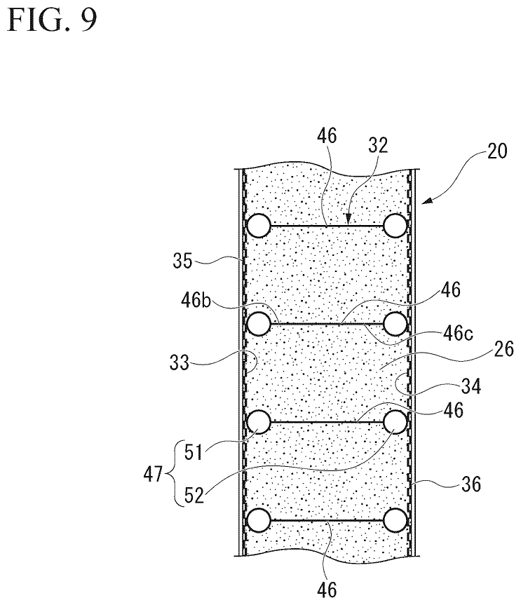

The adsorption modules 20 are filled with an adsorbent 26 (see FIG. 9), and the air introduced from the inflow passage 4 (see FIG. 1 and FIG. 2) is distributed in a plate thickness direction. When the air introduced from the inflow passage 4 is air to be purified in the room, carbon dioxide is adsorbed by the adsorbent 26 as the air passes through the interior. In addition, when the air introduced from the inflow passage 4 is air for regeneration, carbon dioxide on the adsorbent 26 is desorbed when the air for regeneration passes through the interior. A specific structure of the adsorption modules 20 will be described below in detail.

The module holder 15 has an air distribution gap 16 arranged in front of and behind the adsorption modules 20 in the plate thickness direction, and in this state, holds the plurality of adsorption modules 20 in a stacked state. The module holder 15 can be formed of, for example, a resin, a metal, or the like. The module holder 15 includes the pair of disk-shaped end walls 17A and 17B, the pair of connecting walls 18 configured to connect outer circumferential edge portions of the end walls 17A and 17B, and a first shielding wall 19F and a second shielding wall 19S configured to close a part of each of the air distribution gaps 16.

Each of the end walls 17A and 17B is formed to have substantially the same outer diameter as the adsorption modules 20. The plurality of adsorption modules 20 are arranged in layers between the two end walls 17A and 17B. The end walls 17A and 17B are disposed with the air distribution gap 16 sandwiched between the adsorption modules 20 of both end portions in the stacking direction. The adsorption modules 20 and the end walls 17A and 17B are disposed parallel to each other and spaced apart in the stacking direction. Accordingly, the plurality of air distribution gaps 16 arranged facing the front and rear surfaces of each of the adsorption modules 20 are arranged parallel to each other.

Further, in the case of the embodiment, a clearance dimension of the air distribution gap 16 formed between the adsorption modules 20 of both the end portions and the end walls 17A and 17B is set to appropriately half the clearance dimension of the air distribution gap 16 formed between the neighboring adsorption modules 20.

The integrated connecting walls 18 are connected to both the end walls 17A and 17B at positions 180° apart on the circumference. An inner surface of each of the connecting walls 18 is in air-tight contact with an outer circumferential surface of each of the plurality of adsorption modules 20, and the outer surface of each of the connecting walls 18 is in air-tight contact with an inner surface of the casing 3. In a state in which the device main body unit 10 is installed in the casing 3, the pair of connecting walls 18 separate the outer circumferential portion of the plurality of air distribution gaps 16 into an inflow region facing the upstream-side air inflow chamber 11 and an outflow region facing the downstream-side air outflow chamber 12.

The first shielding wall 19F and the second shielding wall 19S are formed in the same shape. The first shielding wall 19F and the second shielding wall 19S are formed in a semi-cylindrical shape with substantially the same inner diameter as the outer circumferential surface of the adsorption modules 20. Both end portions of the first shielding wall 19F and the second shielding wall 19S in the circumferential direction are connected to the pair of connecting walls 18. The first shielding wall 19F comes into air-tight contact with the outer circumferential surfaces of the adsorption modules 20 or the end walls 17A and 17B to shield an outflow region (a left half region in FIG. 2 to FIG. 4) of the air distribution gap 16 in this state. Similarly, the second shielding wall 19S comes into air-tight contact with the outer circumferential surfaces of the adsorption modules 20 or the end walls 17A and 17B to shield an inflow region (a right half region in FIG. 2 to FIG. 4) of the air distribution gap 16 in this state.

The first shielding wall 19F and the second shielding wall 19S are disposed to alternately close the plurality of air distribution gaps 16 in the stacking direction. That is, the first shielding wall 19F shields every other one of the plurality of air distribution gaps 16 disposed in a stacked manner, and the second shielding wall 19S shields every other one of the air distribution gaps 16 that are not partially blocked by the first shielding wall 19F.

Further, in FIG. 3, in order to easily understand the internal structure of the device main body unit 10, parts of the first shielding wall 19F and the second shielding wall 19S are removed, and the removed parts are shown by virtual lines.

When air is introduced into the device main body unit 10 installed in the casing 3 from the inflow passage 4, as shown by an arrow of FIG. 3, the air flows into the air distribution gap 16 that open alternately on the side of the air inflow chamber 11 (a right side in the drawings). In this way, when the air flows into the air distribution gap 16, the air is distributed into the adsorption modules 20 facing the air distribution gap 16 in a plate thickness direction as shown by an arrow in FIG. 4. Further, since the air distribution gap 16, which is open on the side of the air inflow chamber 11, is closed by the first shielding wall 19F on the side of the air outflow chamber 12 (a left side in the drawing), almost all of the air flowing into the air distribution gap 16 is distributed through the adsorption modules 20 in the plate thickness direction.

In addition, the air distributed through the adsorption modules 20 in the plate thickness direction flows out toward the outflow passage 5 through the air distribution gap 16 that is open on the side of the air outflow chamber 12.

In the case of the embodiment, the air inflow chamber 11 formed in the casing 3 is formed with a substantially constant cross-sectional shape in the axial direction of the device main body unit 10, and the overall capacity (volume) is ensured to be sufficiently large. Similarly, the air outflow chamber 12 is also formed with a substantially constant cross-sectional shape in the axial direction of the device main body unit 10, and the overall capacity (volume) is ensured to be sufficiently large. The air inflow chamber 11 and the air outflow chamber 12 configure a pressure buffer that equalizes the air pressure applied to the plurality of adsorption modules 20.

### Adsorption Module

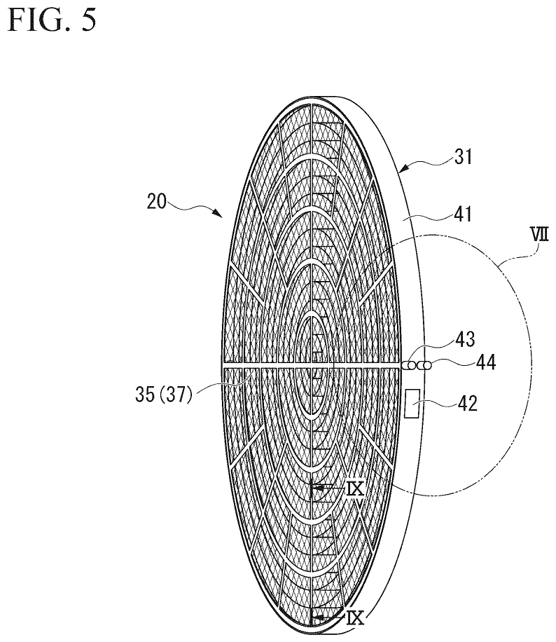

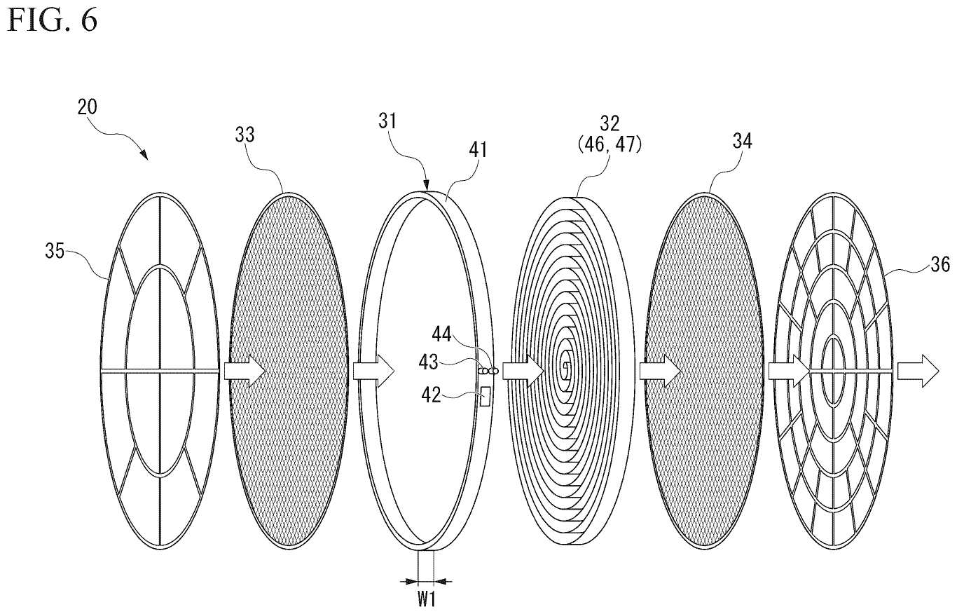

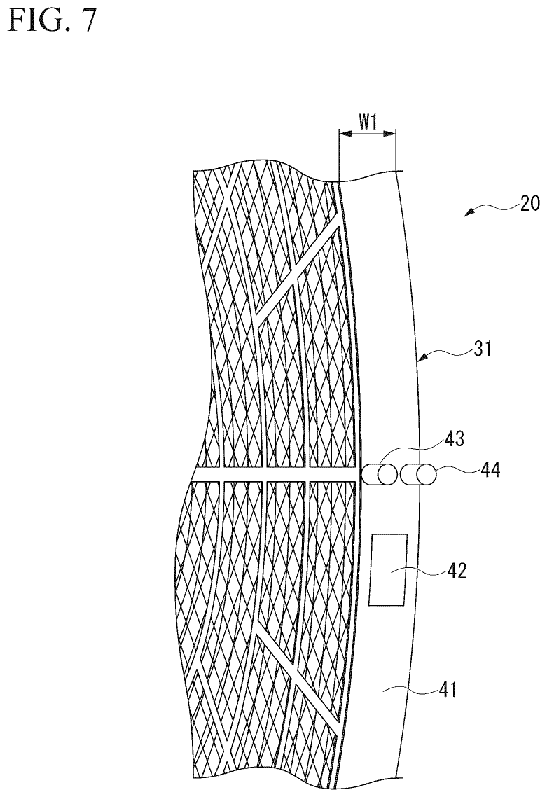

FIG. 5 is a perspective view of the adsorption module 20, and FIG. 6 is an exploded perspective view of the adsorption module 20. FIG. 7 is an enlarged view of a portion VIII in FIG. 5.

The adsorption module 20 includes a frame 31 having a short axis cylindrical shape, a first filter 33 (a first mesh part) configured to close one side of the frame 31 in the axial direction, a second filter 34 (a second mesh part) configured to close the other side of the frame 31 in the axial direction, and a first holder member 35 and a second holder member 36 configured to hold the first filter 33 and the second filter 34, respectively. In addition, the adsorbent 26 and a spiral heat exchange member 32 are accommodated in a disk-shaped space part surrounded by the frame 31, the first filter 33 and the second filter 34 of the adsorption module 20.

### Frame

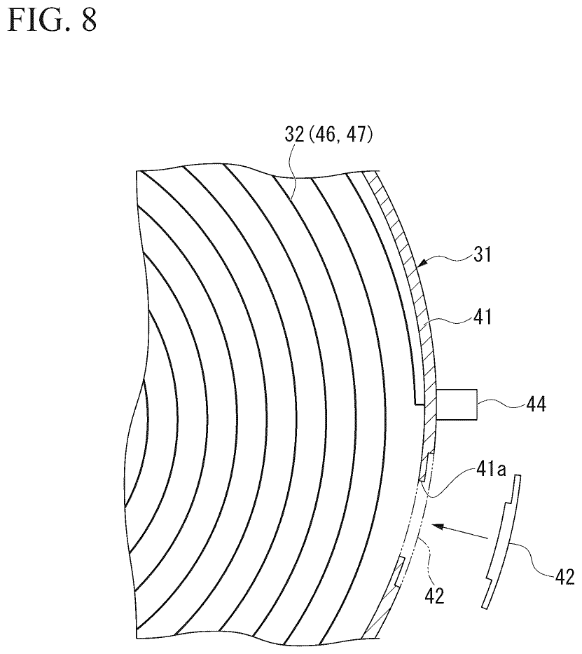

FIG. 8 is a schematic exploded cross-sectional view of the adsorption module 20 in a direction perpendicular to the thickness direction. Further, in FIG. 8, the heat exchange member 32 is simplified and shown.

While the frame 31 can be formed of a metal such as aluminum alloy, steel, or the like, a carbon composite material, or the like, it is preferable to be formed of a non-metal material in consideration of the insulation effect. The frame 31 is formed in a short axis cylindrical shape, and configures an outer circumferential wall of the disk-shaped adsorption module 20. In addition, as shown in FIG. 7 and FIG. 8, the frame 31 includes a frame main body 41 that constitutes a main part of the outer circumference of the adsorption module 20, a lid member 42 detachably attached to an opening part 41a formed in the frame main body 41, a connecting terminal for inflow 43, and a connecting terminal for outflow 44. Hereinafter, the connecting terminal for inflow 43 is referred to as “an inflow connecting terminal 43,” and the connecting terminal for inflow 43 is referred to as “an outflow connecting terminal 44.”

The frame main body 41 has a width dimension W1 (a dimension in the axial direction) in the airflow direction that is set relatively small. Accordingly, the adsorption module 20 is formed in a thin type disk shape with a small thickness in the plate thickness direction.

The opening part 41a of the frame main body 41 is used to flow the adsorbent 26 into the frame 31 or discharge the adsorbent 26 from the inside of the frame 31. In addition, a pair of attachment holes (not shown) are formed in the frame main body 41. The connecting terminal for inflow 43 and the connecting terminal for outflow 44 are attached to these attachment holes. The connecting terminal for inflow 43 and the connecting terminal for outflow 44 are connected to a supply circuit for a heat exchange fluid (not shown). A heated heat exchange fluid or a cooled heat exchange fluid is supplied from the supply circuit.

The following description will be given on the assumption that the heated heat exchange fluid is supplied from the supply circuit. The heated heat exchange fluid passes through the heat exchange member 32 and heats the adsorbent 26, thereby easily desorbing the carbon dioxide adsorbed in the adsorbent 26 (regenerating the adsorbent 26). Further, when the cooled heat exchange fluid is supplied from the supply circuit, the adsorbent 26 can be cooled by cold from the heat exchange fluid, and thus, adsorption performance of the adsorbent 26 can be increased. However, during operation of adsorption of the carbon dioxide, it is not particularly necessary to flow the cooled heat exchange fluid.

### Heat Exchange Member

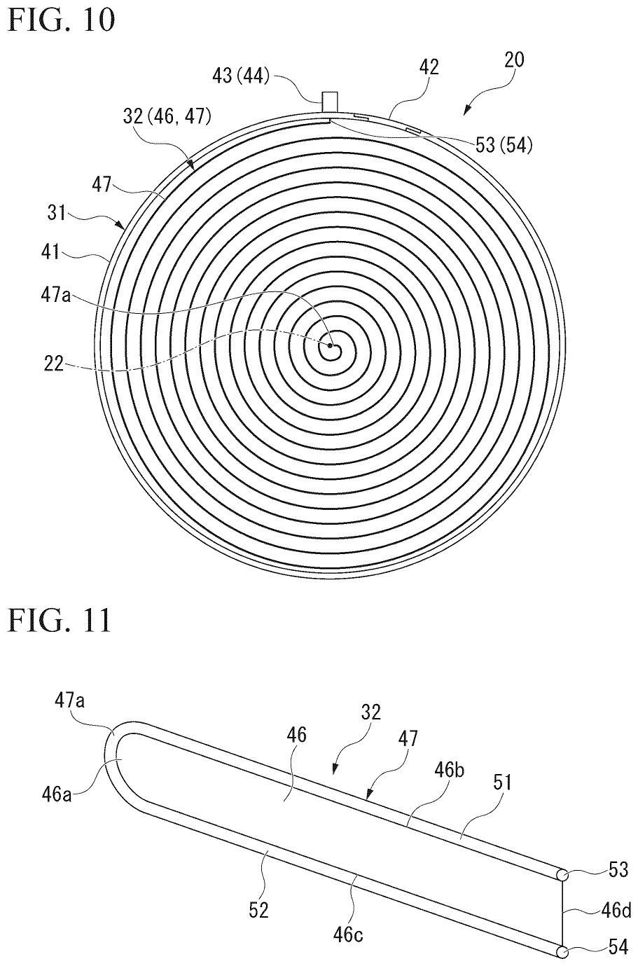

FIG. 9 is a cross-sectional view of the adsorption module 20 along line X-IX in FIG. 5. FIG. 10 is a schematic cross-sectional view of the adsorption module 20 in a direction perpendicular to the thickness direction, and FIG. 11 is a perspective view showing a state in which the heat exchange member 32 of the adsorption module 20 deployed. Further, in FIG. 10, the heat exchange member 32 is simplified and shown.

The heat exchange member 32 is disposed (received) at inner side of the frame 31. The heat exchange member 32 includes a heat exchange film 46, and a heat exchange tube 47. The heat exchange film 46 is formed of a metal with high thermal conductivity such as copper, aluminum alloy, or the like, in a thin film belt shape, and a tip portion 46a is formed in a U shape. The heat exchange film 46 is disposed such that the widthwise direction is parallel to an airflow direction (an axial direction of the adsorption module 20).

Hereinafter, in side edges of the heat exchange film 46, a side edge located on an upstream side of air current is referred to as “a first side edge 46b” and a side edge located on a downstream side of the air current is referred to as “a second side edge 46c.” In addition, the tip portion 46a of the heat exchange film 46 may be referred to as “the U-shaped tip portion 46a.”

The heat exchange tube 47 is connected to a circumferential edge of the heat exchange film 46. The heat exchange tube 47 is formed of a metal with high thermal conductivity such as copper, aluminum alloy, or the like, in a hollow shape. The heat exchange tube 47 has an upstream tube region 51 disposed on one side of the adsorption module 20 in the plate thickness direction, a downstream tube region 52 disposed on the other side of the adsorption module 20 in the plate thickness direction, an inflow port 53, and an outflow port 54.

The upstream tube region 51 is connected to an upstream side in the airflow direction along the first side edge 46b of the heat exchange film 46, and extends to the U-shaped tip portion 46a of the heat exchange film 46. The downstream tube region 52 is connected to a downstream side in the airflow direction along the second side edge 46c of the heat exchange film 46, and extends to the U-shaped tip portion 46a of the heat exchange film 46.

The upstream tube region 51 and the downstream tube region 52 are integrally connected in the U-shaped tip portion 46a. The upstream tube region 51 and the downstream tube region 52 are in communication with each other in a U-shaped turn-around region 47a along the U-shaped tip portion 46a of the heat exchange film 46. The upstream tube region 51, the turn-around region 47a, and the downstream tube region 52 of the heat exchange tube 47 are disposed parallel to a distribution direction of the air current in the frame 31.

The heat exchange film 46 and the heat exchange tube 47 of the above-mentioned configuration are formed in a spiral shape centered on the U-shaped tip portion 46a and the turn-around region 47a in a direction crossing the airflow direction. Accordingly, the heat exchange film 46 is disposed such that the base end portion 46d is positioned outside the radial direction centered on an axis 22. In addition, the heat exchange tube 47 is disposed such that the inflow port 53 and the outflow port 54 are positioned outside the radial direction centered on the axis 22.

The inflow port 53 is provided in a base end portion of the upstream tube region 51. The inflow port 53 is an opening through which a heat exchange fluid flows into the upstream tube region 51 (the heat exchange tube 47). The inflow port 53 is connected to the inflow connecting terminal 43 via one attachment hole (not shown) of the frame main body 41. Meanwhile, the upstream tube region 51 is disposed such that other area than the inflow port 53 comes into non-contact with the frame main body 41 (the frame 31).

Further, the inflow port 53 is connected to the supply circuit for a heat exchange fluid via the inflow connecting terminal 43. Accordingly, the heat exchange fluid supplied from the supply circuit flows into the inflow port 53 via the inflow connecting terminal 43, and further flows into the upstream tube region 51.

In addition, the outflow port 54 is provided on a base end portion of the downstream tube region 52. The outflow port 54 is an opening through which a heat exchange fluid flows out of the inside of the downstream tube region 52 (the heat exchange tube 47). The outflow port 54 is connected to the outflow connecting terminal 44 via the other attachment hole (not shown) of the frame main body 41. Meanwhile, the downstream tube region 52 is disposed such other area than the outflow port 54 comes into non-contact with the frame main body 41 (the frame 31).

Further, the heat exchange film 46 is disposed to come into non-contact with the frame main body 41 (the frame 31) as a whole.

Further, the outflow port 54 is connected to the supply circuit via the outflow connecting terminal 44. Accordingly, the heat exchange fluid flowing through the downstream tube region 52 is collected from the outflow port 54 and returned to the supply circuit via the outflow connecting terminal 44.

In this way, in the heat exchange member 32, in a state in which the heat exchange film 46 and the heat exchange tube 47 are formed in a spiral shape, the upstream tube region 51 is disposed on the upstream side in the airflow direction and the downstream tube region 52 is disposed on the downstream side in the airflow direction. In addition, the heat exchange member 32 is received in the frame 31 in a state in which only the inflow port 53 and the outflow port 54 are connected to the frame 31.

In addition, the heat exchange film 46 is set such that the width dimension in the airflow direction is sufficiently small. For this reason, the heat exchange member 32 formed in the spiral shape is formed in a flat shape with a sufficiently small width dimension in the airflow direction. A space between the flat heat exchange members 32 formed in the spiral shape is filled with the adsorbent 26. Accordingly, the adsorbent 26 is received at inner side of the frame 31 in a flat shape.

According to the heat exchange member 32, the heat exchange fluid flows into the turn-around region 47a from the inflow port 53 via the inside of the upstream tube region 51. Further, the heat exchange fluid flowing to the turn-around region 47a flows to the outflow port 54 via the inside of the downstream tube region 52, and flows out to the adsorption modules 20 from the outflow port 54.

Here, the turn-around region 47a of the heat exchange tube 47 is located at a spiral center. In addition, the inflow port 53 and the outflow port 54 are located on a spiral outer circumferential end. Accordingly, the heat exchange fluid is supplied from the spiral outer circumferential end (the inflow port 53) in the heat exchange tube 47, folded back at the spiral center (the turn-around region 47a) to become countercurrent, and collected from the spiral outer circumferential end (the outflow port 54). The collected heat exchange fluid is temperature-adjusted in the supply circuit, and re-flowed into the upstream tube region 51 (the heat exchange tube 47) from the inflow port 53.

In this way, by folding the heat exchange fluid around the turn-around region 47a to create the countercurrent, the entire heat exchange tube 47 can be heated to a uniform temperature. Accordingly, the entire heat exchange film 46 can also be heated to a uniform temperature. As a result, the entire adsorbent 26 can be heated to a uniform temperature.

### First Filter

As shown in FIG. 6 and FIG. 9, the first filter 33 is disposed on the upstream side of the heat exchange member 32. The first filter 33 is formed in a disk shape with a mesh structure. The first filter 33 may be formed of, for example, woven wire mesh, sintered wire mesh, sintered metal fiber nonwoven fabric, perforated wire mesh, or may be formed of fibers such as cellulose, carbon, or the like. Accordingly, the first filter 33 can retain the particles of the adsorbent 26 so that they do not leak to the upstream side of the heat exchange member 32, and furthermore has air permeability that keeps the resistance of the distribution air sufficiently low. In addition, the first filter 33 is designed to have the function of blocking the passage of foreign substances.

### Second Filter

The second filter 34 is disposed on the downstream side of the heat exchange member 32. The second filter 34 is formed in a disk shape with a mesh structure. The second filter 34 may be formed of, for example, woven wire mesh, sintered wire mesh, sintered metal fiber nonwoven fabric, perforated wire mesh, or may be formed of fibers such as cellulose, carbon, or the like. Accordingly, the second filter 34 can retain the particles of the adsorbent 26 so that they do not leak to the downstream side of the heat exchange member 32, and furthermore has air permeability that keeps the resistance of the distribution air sufficiently low.

That is, the first filter 33 and the second filter 34 sandwich the heat exchange member 32 from the upstream side and the downstream side in the airflow direction. Accordingly, the adsorbent 26 received (disposed) between the heat exchange tubes 47 of the heat exchange member 32 can be held from the upstream side and the downstream side.

### First Holder Member

The first holder member 35 is provided on the upstream side of the first filter 33. The first holder member 35 is formed in a disk shape with a truss structure. The first holder member 35 is formed of fibers, for example, metal, carbon composite molding, or the like. The first holder member 35 is easy to assemble, disassemble, and can be simply replaced. By providing the first holder member 35 on the upstream side of the first filter 33, deformation of the first filter 33, which is relatively flexible, can be suppressed.

### Second Holder Member

The second holder member 36 is provided on the downstream side of the second filter 34. The second holder member 36 is formed in a disk shape with a truss structure. The second holder member 36 is formed by fibers, for example, metal, carbon composite molding, or the like. The second holder member 36 is easy to assemble and disassemble, and can be simply replaced. By providing the second holder member 36 on the downstream side of the second filter 34, deformation of the second filter 34, which is relatively flexible, can be suppressed.

The second holder member 36 is further formed to be stronger than the second holder member 36 in order to effectively prevent uneven distribution of the adsorbent 26 due to the distribution air.

That is, the first holder member 35 and the second holder member 36 sandwich the first filter 33 and the second filter 34 from the upstream side and the downstream side in the airflow direction, and the first filter 33 and the second filter 34 can be held from the upstream side and the downstream side. Accordingly, it is possible to prevent the adsorbent 26 from being deformed due to uneven distribution caused by distribution air or gravity.

### Adsorbent

As shown in FIG. 9, a space between the heat exchange members 32 formed in a spiral shape is filled with the adsorbent 26. More specifically, the adsorbent 26 is filled between the heat exchange tubes 47 formed in a spiral shape and between the heat exchange films 46 formed in a spiral shape. The adsorbent 26 may be a solid adsorbent formed by particles, such as beads or pellets, or the like. The adsorbent 26 is received in the frame 31 while being filled between the heat exchange members 32 formed in the spiral shape.

Here, the adsorbent 26 is maintained in a flat shape with the width dimension in the airflow direction kept relatively small while being received in the frame 31. Accordingly, the pressure loss caused by the adsorbent 26 can be kept low.

As described above, in the adsorption device 1 of the embodiment, the plurality of disk-shaped adsorption modules 20 are held while being stacked by the module holder 15, and the air distribution gap 16 is disposed in front of and behind each of the adsorption modules 20 in the plate thickness direction. The outer circumferential portion of the plurality of air distribution gaps 16 is separated into the inflow region and the outflow region by the pair of connecting walls 18 of the module holder 15, and the plurality of air distribution gaps 16 are alternately closed in the stacking direction by the semi-cylindrical first shielding wall 19F and the semi-cylindrical second shielding wall 19S. For this reason, the adsorption device 1 of this embodiment has a simple configuration that can reduce the distribution resistance of air, and can distribute the air in parallel to the plurality of adsorption modules 20.

Accordingly, when the adsorption device 1 of the embodiment is employed, it is possible to achieve easier manufacturing, improved efficiency in the adsorption and desorption of adsorption target substances, and reduced energy consumption for air distribution. Then, this can ultimately contribute to mitigating or reducing the impact of climate change.

In addition, in the adsorption device 1 of the embodiment, the adsorption module 20 includes the annular frame 31, and the adsorbent 26 and the heat exchange tube 47 (heat exchange member) disposed at inner side of the frame 31. Then, the heat exchange tube 47 has the upstream tube region 51 disposed on one side of the adsorption module 20 in the plate thickness direction, the downstream tube region 52 disposed on the other side in the plate thickness direction, and the substantially U-shaped turn-around region 47a that connects the upstream tube region 51 and the downstream tube region 52. Further, the heat exchange tube 47 is formed in a spiral shape such that the turn-around region 47a is located in a substantially central portion at inner side of the frame 31. For this reason, when the heat exchange fluid is introduced into the heat exchange tube 47, the heat exchange fluid flows into the turn-around region 47a located at substantially a center of the frame 31 through the upstream tube region 51, and flows out to the outside from the turn-around region 47a through the downstream tube region 52. Accordingly, the heat exchange fluid flows through the upstream tube region 51 and the downstream tube region 52 in opposite directions as a countercurrent. For this reason, when the temperature of the heat exchange fluid is gradually decreased from the outer side toward the inner side of the frame 31 in the radial direction in the upstream tube region 51, the temperature of the heat exchange fluid is gradually increased conversely from the inner side toward the outer side of the frame 31 in the radial direction in the downstream tube region 52.

Accordingly, when the configuration of the embodiment is employed, an average temperature in the plate thickness direction of the adsorption modules 20 is almost uniform throughout the radial direction. Accordingly, when the adsorption device 1 of the embodiment is employed, it is possible to increase desorption efficiency of the carbon dioxide from the adsorption modules 20 (regeneration efficiency of the adsorption modules 20) or adsorption efficiency of the carbon dioxide in the adsorption modules 20.

In addition, in the adsorption device 1 of the embodiment, the air inflow chamber 11 and the air outflow chamber 12 facing the device main body unit 10 constitute a pressure buffer that uniformized the air pressure applied to the plurality of adsorption modules 20. For this reason, the pressure buffer equalizes the air pressure applied to the plurality of adsorption modules 20, allowing the air to flow more uniformly to each of the adsorption modules 20. Accordingly, when the configuration is employed, it is possible to further increase desorption efficiency of the carbon dioxide from the adsorption modules 20 (regeneration efficiency of the adsorption modules 20) or adsorption efficiency of the carbon dioxide in the adsorption modules 20

Further, while both the air inflow chamber 11 and the air outflow chamber 12 constitute the pressure buffer in the embodiment, only one of the air inflow chamber 11 and the air outflow chamber 12 may constitute the pressure buffer.

### Second Embodiment

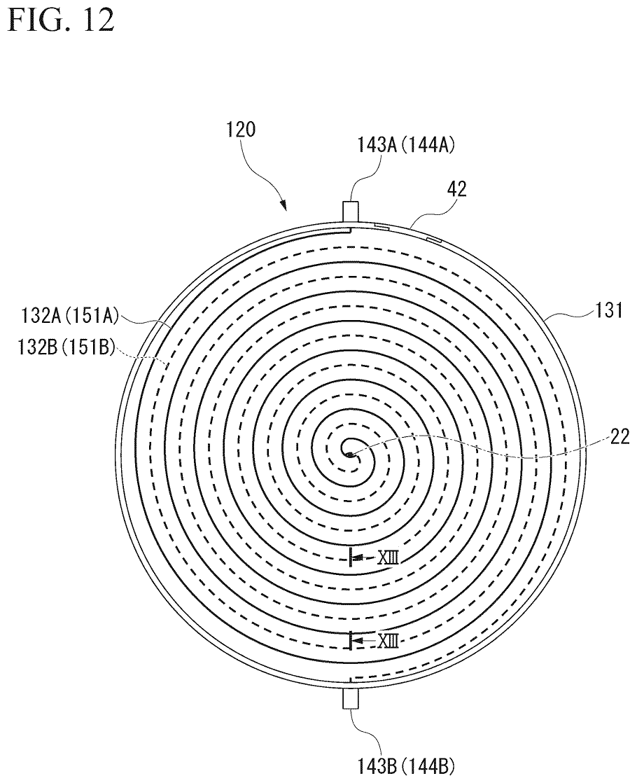

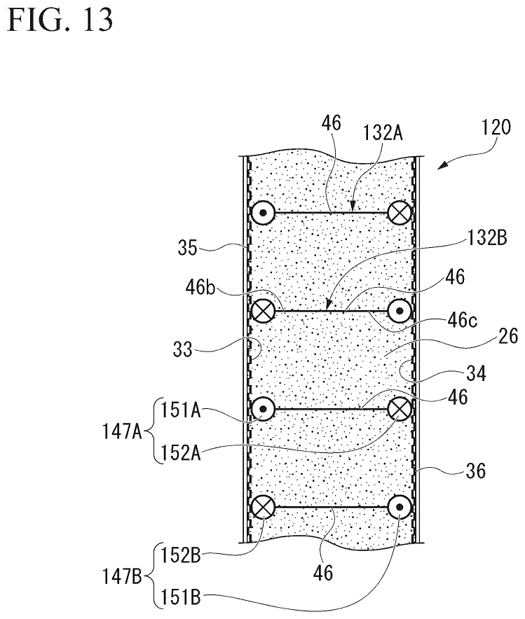

FIG. 12 is a schematic cross-sectional view of an adsorption module 120 of an embodiment in a direction perpendicular to the thickness direction. FIG. 12 is the same cross-sectional view as in FIG. 10 of the first embodiment. FIG. 13 is a cross-sectional view along line XIII-XIII in FIG. 12.

In an adsorption device of the embodiment, only the configuration of the adsorption module 120 is different from that of the first embodiment, and the other of the configuration is the same as that of the first embodiment. The adsorption module 120 of this embodiment has two heat exchange parts through which the heat exchange fluid flows. Specifically, the adsorption module 120 includes a first heat exchange member 132A and a second heat exchange member 132B, which have the same configuration. In FIG. 12, the first heat exchange member 132A is drawn by a solid line, and the second heat exchange member 132B is drawn by a dotted line. The first heat exchange member 132A and the second heat exchange member 132B are configured as double windings with a phase difference of 180°.

The first heat exchange member 132A and the second heat exchange member 132B are formed in a spiral shape concentrically centered on the axis 22 and in the same direction. The first heat exchange member 132A and the second heat exchange member 132B include heat exchange tubes 147A and 147B, respectively. The heat exchange tubes 147A and 147B have upstream tube regions 151A and 151B and downstream tube regions 152A and 152B, respectively, like the first embodiment. The upstream tube regions 151A and 151B and the downstream tube regions 152A and 152B are connected by substantially U-shaped turn-around regions (not shown). The two heat exchange tubes 147A and 147B have turn-around regions arranged at approximately the center position of the frame 31 (the position of the axis 22).

The same heat exchange film 46 as in the first embodiment is adhered to the heat exchange tubes 147A and 147B of the first heat exchange member 132A and the second heat exchange member 132B. In addition, inflow connecting terminals 143A and 143B and outflow terminals 144A and 144B are connected to end portions of the heat exchange tubes 147A and 147B of the first heat exchange member 132A and the second heat exchange member 132B, respectively.

In addition, as shown in FIG. 13, in the one heat exchange tube 147A, the upstream tube region 151A is disposed on one side of the adsorption module 120 in the plate thickness direction (a left side in FIG. 13), and the downstream tube region 152A is disposed on the other side of the adsorption module 120 in the plate thickness direction (a right side in FIG. 13). On the contrary, in the other heat exchange tube 147B, the upstream tube region 151B is disposed on the other side of the adsorption module 120 in the plate thickness direction, and the downstream tube region 152B is disposed on one side of the adsorption module 120 in the plate thickness direction.

The absorption device of this embodiment differs only in the specific configuration of the absorption module 120, and other basic configurations are similar to those of the first embodiment. For this reason, the absorption device of this embodiment can obtain the same basic effect as that of the first embodiment described above.

In addition, the adsorption device of this embodiment allows the heat exchange fluid to flow individually into the two heat exchange tubes 147A and 147B of the adsorption module 120. For this reason, the temperature difference between the upstream tube regions 151A and 151B and the downstream tube regions 152A and 152B of the heat exchange tubes 147A and 147B can be reduced by shortening the spiral length of the heat exchange tubes 147A and 147B. Accordingly, it is possible to more uniformly heat or cool the entire region of the adsorption module 120.

In addition, in the adsorption module 120 of the adsorption device of the embodiment, dispositions of the upstream tube regions 151A and 151B and the downstream tube regions 152A and 152B of the two heat exchange tubes 147A and 147B in the plate thickness direction of the adsorption module 120 are set opposite to each other. For this reason, deviation in temperature distribution of the adsorption module 120 in the plate thickness direction can be further reduced.

### Another Embodiment

In the first embodiment, the adsorption module has one heat exchange tube, and in the second embodiment, the adsorption module has two heat exchange tubes. However, the adsorption module may have three or more heat exchange tubes.

In this case, like the second embodiment, it is desirable to reversely set disposition of the upstream tube regions and the downstream tube regions of the neighboring heat exchange tube in the plate thickness direction of the adsorption module. With this configuration, it is possible to further reduce the deviation in temperature distribution of the adsorption module in the plate thickness direction.

However, when the adsorption module having three or more heat exchange tubes is employed, disposition of the upstream tube regions and the downstream tube regions of the all neighboring heat exchange tubes does not have to be reversed. In this case, by reversing the disposition of the upstream tube region and the downstream tube region of at least one heat exchange tube from that of the other heat exchange tubes, the deviation in temperature distribution in the plate thickness direction of the adsorption module can be reduced.

Further, the present invention is not limited to the above-mentioned embodiment, and various design modifications may be made without departing from the scope of the present invention. For example, in the embodiment shown in FIG. 1, while the introduction fan 6 is disposed in the outflow passage 5, a fan for air supply may be disposed in the inflow passage 4.

In addition, the present embodiment may be used with a plurality of similarly configured absorption devices arranged in an array. In this case, the plurality of adsorption devices arranged in an array may be accommodated in a common case, and the purified air may be returned into the room by a fan placed at the top of the case.

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

What is claimed is:

1. An adsorption device comprising:
a plurality of disk-shaped adsorption modules configured to hold an adsorbent therein and distribute air in a plate thickness direction; and
a module holder for air insulation that has air distribution gaps arranged in front of and behind each of the adsorption module in the plate thickness direction and that is configured to hold the plurality of adsorption modules in a stacked state,
wherein the module holder includes:
a pair of end walls disposed on the adsorption modules of both end portions in a stacking direction with the air distribution gap sandwiched therebetween;
a pair of connecting walls that are configured to separate an outer circumferential portion of the plurality of air distribution gaps into an outflow region facing a downstream-side air outflow chamber and an inflow region facing an upstream-side air inflow chamber and that are configured to connect outer circumferential edge portions of the pair of the end walls;
a semi-cylindrical first shielding wall configured to shield the outflow region outside the air distribution gap; and
a semi-cylindrical second shielding wall configured to shield the inflow region outside the air distribution gap, and
wherein the first shielding wall and the second shielding wall are disposed to alternately close the plurality of air distribution gaps in the stacking direction.

2. The adsorption device according to claim 1, wherein the adsorption module includes:
a frame configured to cover surroundings of the adsorption module in a direction crossing the plate thickness direction;
an adsorbent disposed at inner side of the frame; and
a heat exchange tube that is disposed at the inner side of the frame together with the adsorbent and that is configured to allow heat exchange between a heat exchange fluid distributed in the heat exchange tube and surroundings of the adsorbent,
the heat exchange tube includes:
an upstream tube region disposed on one side of the heat exchange tube in the plate thickness direction;
a downstream tube region disposed on other side of the heat exchange tube in the plate thickness direction; and
a substantially U-shaped turn-around region configured to connect the upstream tube region and the downstream tube region, and
wherein the heat exchange tube is formed in a spiral shape such that the turn-around region is located on a substantially central portion at the inner side the frame.

3. The adsorption device according to claim 2, wherein a plurality of heat exchange tubes are disposed at the inner side of the frame, and
in at least one of the heat exchange tube, a disposition of the upstream tube region and the downstream tube region in the plate thickness direction is set to be opposite to that of a disposition of the other heat exchange tubes.

4. The adsorption device according to claim 3, wherein arrangements of the upstream tube region and the downstream tube region of adjacent heat exchange tubes of the plurality of heat exchange tubes disposed at the inner side of the frame are made opposite to each other in the plate thickness direction.

5. The adsorption device according to claim 1. wherein at least one of the air inflow chamber and the air outflow chamber constitutes a pressure buffer configured to uniformize an air pressure applied to the plurality of adsorption modules.
